(19) United States
(12) Patent Application Publication
(10) Pub. No.: US 2008/0023859 A1
(43) Pub. Date: Jan. 31, 2008

(54) Glycopeptides and Temperature-Responsive Micelles

(75) Inventors: Yoshiko Miura, Ishikawa (JP); Chieri Shibata, Kanagawa (JP); Kazukiyo Kobayashi, Aichi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Toagosei Co., Ltd., Minato-ku, Tokyo (JP)

(21) Appl. No.: 10/580,782

(22) PCT Filed: May 27, 2004
(86) PCT No.: PCT/JP04/07246

§ 371 Date: Apr. 5, 2007

(30) Foreign Application Priority Data
Nov. 28, 2003 (JP) 2003400817

(51) Int. Cl. B01J 13/00

(52) U.S. Cl. 264/4.1

(57) ABSTRACT

Temperature-responsive amphipathic glycopeptides and temperature-responsive micelles are provided by utilizing oligopeptide. A synthesized glycopeptide that does not occur naturally and is represented by the following chemical formula (1), and a temperature-responsive micelle composed of the glycopeptide are provided.

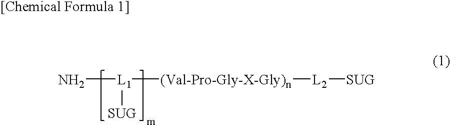

(where x is any amino acid residue, L₁ and L₂ are linkers, SUGs are sugar chains, m is 0 or 1 and n is an integer from 1 to 10, and L₁ and L₂ may be identical with or different from each other and SUGs may be identical with or different from each other.)

### FIELD OF THE PRESENT INVENTION

The present invention relates to glycopeptides, which are temperature-responsive amphipathic compounds, and temperature-responsive micelles composed of the glycopeptides. More particularly, the present invention relates to glycopeptides and micelles that are useful in new formulation for Drug Delivery System (DDS) and microreactors.

### BACKGROUND ART

Most of the conventional temperature-responsive amphipathic compounds are mainly polymers using poly N-isopropylacrylamide or poly(N,N-diethyl acrylamide) (see for example, Macromolecules, 1998, 31, p. 2394, J. Am Chem. Soc., 1996, 118, p. 6092). It is known that these compounds and block copolymers of water-soluble polymers act as temperature-responsive surfactants. However, it is not easy to obtain the block polymers of these compounds. In addition, it is not easy to control the degree of polymerization at angstrom level in these high-molecular compounds.

Moreover, the monomers of the conventional temperature-responsive polymers are acrylamide or the like having high biotoxicity, and the development of temperature-responsive materials without using vinyl compound has been desired.

Synthesis of polymers using the model sequence of elastin, the elastin being an extracellular matrix, has been considered as a way to produce a temperature-responsive material having high biological safety. So far, it has been shown that multimers of the amino acids having repetitive sequences such as Val-Pro-Gly-Val-Gly or Gly-Val-Pro-Gly-Val-Gly act as temperature-responsive polymers (see for example, Macromolecules, 1999, 32, p. 9067, Biomacromolecules, 2000, 1, p. 552.). In addition, it has been reported that the peptides in which the fourth residue of the elastin model sequence is changed also exhibit temperature-responsiveness (see J. Phys. Chem. B, 1997, 101, p. 11007).

However, similar to vinyl temperature-responsive polymers such as poly N-isopropylacrylamide, such high-molecular compounds did not achieve the compounds controlled at the angstrom level.

Non-patent Document 1: Macromolecules, 1998, 31, p. 2394

Non-patent Document 2: J. Am Chem. Soc., 1996, 118, p. 6092

Non-patent Document 3: Macromolecules, 1999, 32, p.9067

Non-patent Document 4: Biomacromolecules, 2000, 1, p. 552

Non-patent Document 5: J. Phys. Chem. B, 1997, 101, p. 11007

### DISCLOSURE OF INVENTION

### Problem(s) to be Solved by the Present Invention

In light of the aforementioned problems, the present invention intends to provide amphipathic glycopeptides having temperature-responsiveness by using oligopeptides. Particularly, it is an object of the present invention to provide compounds having high biocompatibility and temperature-responsiveness at the angstrom level and to provide compounds useful in biomaterials, drug delivery, agriculture or the like.

### Means for Solving the Problem

It was discovered that glycopeptides, which is a combination of the elastin model peptide (-(Val-Pro-Gly-Val-Gly)ₙ-) of which hydrophilicity and hydrophobicity change according to temperature, and a hydrophilic sugar chain have specific temperature-responsiveness, thereby leading to the completion of the present invention.

Therefore, the present invention is directed to a synthesized glycopeptide that does not occur naturally and is represented by the following chemical formula (1), and a temperature-responsive micelle composed of the glycopeptide.

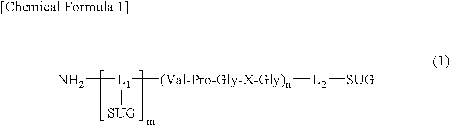

(where x is any amino acid residue, L₁ and L₂ are linkers, SUGs are sugar chains, m is 0 or 1 and n is an integer from 1 to 10, and L₁ and L₂ may be identical with or different from each other and SUGs may be identical with or different from each other.)

### Advantageous Effect of the Present Invention

Glycopeptides of the present invention are reversible and have quick temperature-responsiveness, and micelles composed of glycopeptides of the present invention have temperature-responsiveness by which the particle diameters change within a temperature range.

The glycopeptides of the present invention are temperature-responsive molecules at angstrom level, and are used in Drug Delivery Systems or other molecular devices which require accurate responsiveness.

In addition, the glycopeptides of the present invention are composed of the molecular structures having high biocompatibility and serve as compounds suitable for biomaterials or agricultural materials.

Moreover, it is known that sugars specifically interact with cells, pathogens, toxins and viruses, and the glycopeptides of the present invention are expected to be advantageously used in drugs that inhibit pathogens according to temperatures.

### BRIEF DESCRIPTION OF THE DRAWINGS

FIG. 1 is a diagram showing a synthesis flowchart of Compound 1, Compound 4 and Compound 8;

FIG. 2 is a diagram showing a CD spectrum of Compound 1 (relation-diagram of wavelength and molecular ellipticity);

FIG. 3 is a diagram showing a CD spectrum of Compound 1 (relation-diagram of temperature and molecular ellipticity);

FIG. 4 is a diagram showing a CD spectrum of Compound 4 (relation-diagram of wavelength and molecular ellipticity);

FIG. 5 is a diagram showing a CD spectrum of Compound 4 (relation-diagram of temperature and molecular ellipticity);

FIG. 6 is a diagram showing a CD spectrum of Compound 8 (relation-diagram of wavelength and molecular ellipticity);

FIG. 7 is a diagram showing a CD spectrum of Compound 8 (relation-diagram of temperature and molecular ellipticity);

FIG. 8 is a diagram showing a CD spectrum of a reference compound (NH2-Val-Pro-Gly-Val-Gly-Val-Pro-Gly-Val-Gly-OH) (relation-diagram of wavelength and molecular ellipticity);

FIG. 9 is a diagram showing a CD spectrum of a reference compound (NH2-Val-Pro-Gly-Val-Gly-Val-Pro-Gly-Val-Gly-OH) (relation-diagram of temperature and molecular ellipticity);

FIG. 10 is a diagram showing the DLS measurement results of Compounds 1, 4 and 8;

FIG. 11 is a diagram showing the temperature responsiveness of a micelle composed of Compound 1; and

FIG. 12 is a diagram of π-A curves (pressure-area curves) of the interface between gas and liquid of Compound 1.

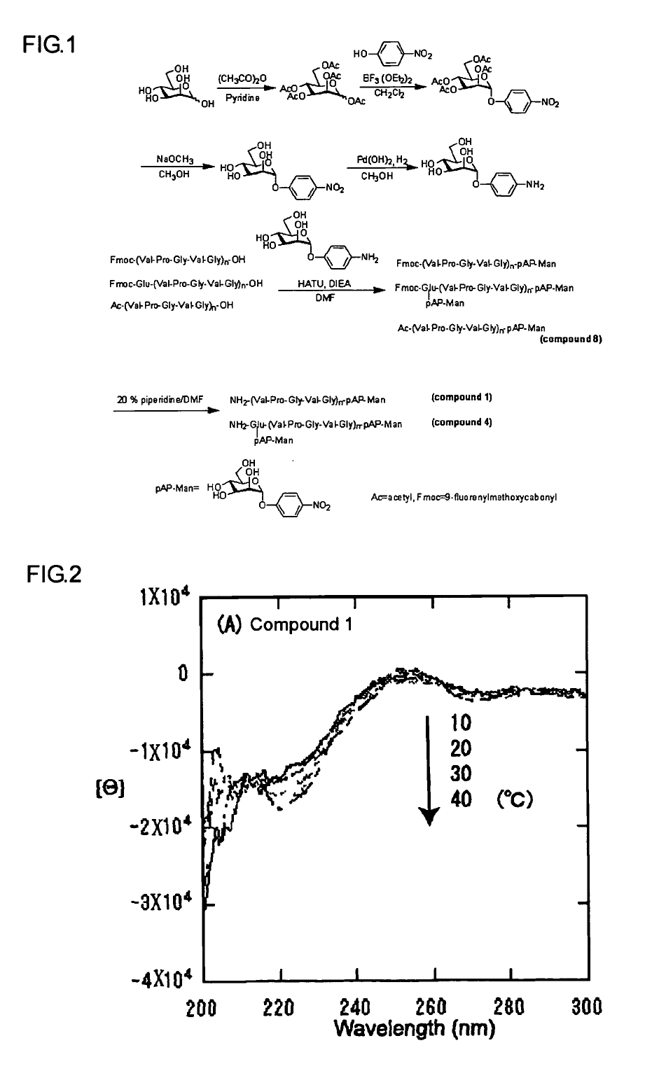

### BEST MODE FOR CARRYING OUT THE PRESENT INVENTION

### Sugar Chain

The sugar chains applicable to the glycopeptides of the present invention are preferably sugar chains of monosaccharide or oligosaccharide, and more preferably sugar chains of mono-, di-, or trisaccharide.

The preferable examples of monosaccharide include mannose, α, β-glucose, galactose, fucose, sialic acid, glucosamine, N-acetyl-glucosamine, N-acetyl-galactosamine and the like.

The preferable examples of oligosaccharide include maltose, cellobiose, lactose, isomaltose, chitobiose, chitotriose, cellotriose, maltotriose, cellotetraose, chitotetraose, cellopentaose, maltotetraose, maltopentaose, chitopentaose, cellohexaose, chitohexaose and the like.

The sugar chains in the glycopeptides of the present invention constitute hydrophilic groups, and sugars are appropriately selected by taking into consideration the hydrophilicity/hydrophobicity of the elastin model peptide, since the glycopeptides are amphipathic when the peptides aggregate in response to temperatures.

### Linker

In the present invention, there is no limitation regarding a linker between a peptide and a sugar chain so long as the linker has organic groups bonding the peptide and the sugar chain.

Linker L₂ provided at the C-terminal side is preferably paraamidephenoxide, alkylamine, ethyleneglycol amine or the like.

L₁ in the above formula (1) is a linker for bonding a sugar chain to the N-terminal side of the peptide chain. Then, preferably by incorporating an amino acid having a carboxyl group such as a glutamic acid or an aspartic acid into the peptide chain, the linker easily bond sugar chains through the additional linker that is similar to the linker L₂ provided at the C-terminal side.

### Peptide

The peptide of the present invention has a sequence of (Val-Pro-Gly-X-Gly)n or (Glu-Val-Pro-Gly-X-Gly)n (where X is any amino acid residue and n is an integer between 1 to 10) which is the oligopeptide of elastin model peptide.

In a preferable peptide, the X in the sequence is Val.

In the case where monosaccharide is used as sugars, the peptides forming the micelles having quick temperature-responsiveness are suitably peptides containing five amino acid residues or ten amino acid residues. A longer peptide chain can be used, but in that case, it is desirable to bond a longer oligosaccharide chain thereto so as to keep the balance of amphipathicity. For example, it is possible to bond an oligosaccharide chain to the peptide containing ten to forty amino acid residues, thereby producing temperature-responsive and amphipathic glycopeptides.

Moreover, in the present invention, apart from unprotected amino group, the N-terminal of the peptide can also be an acetyl group or a group that is protected by a Boc group (t-Butyloxycarbonyl) or a Fmoc group (9-Fluorenylmethoxycarbonyl).

Elastin oligopeptide ((Val-Pro-Gly-Val-Gly), (Val-Pro-Gly-X-Gly), where X is any amino acid residue) used in the present invention is easily provided through peptide synthesis. The peptide synthesis can be easily achieved by the known solution phase synthesis or solid phase synthesis.

The first preferred embodiment of the present invention is a glycopeptide of which monosaccharide mannose is bonded to a peptide having the oligopeptide sequence of the elastin model peptide via paraamidephenoxide, which serves as a linker. Specifically, the following glycopeptide is provided as an example.

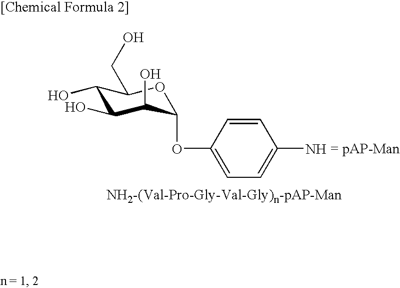

The second preferred embodiment of the present invention is a glycopeptide of which the sequence of the elastin model peptide is partially modified. So far, it has been reported that peptides of which the fourth residue of the elastin model sequence is modified also exhibit temperature-responsiveness (see J. Phys. Chem. B, 1997, 101, p. 11007). Therefore, compounds of which sequence is partially modified also exhibit temperature-responsiveness. Specifically, the following glycopeptide is provided as an example.

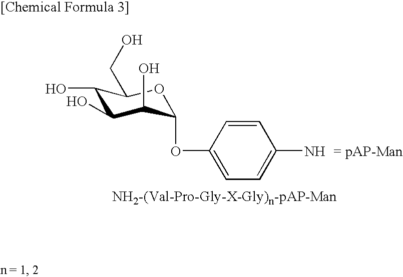

(where X is any amino acid residue.)

The third preferred embodiment of the present invention provides the glycopeptide of which sugar parts that are bonded to the elastin model peptide are modified to various sugar chains.

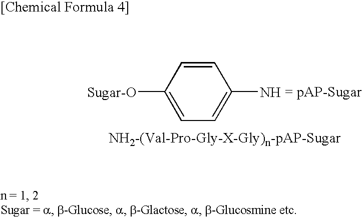

(where X is any amino acid residue.)

The fourth preferred embodiment of the present invention is a glycopeptide of which the C-terminal of the elastin model peptide is bonded to a mannose via paraamidephenoxide, which serves as a linker, and the N-terminal thereof is bonded to a mannose via the side chain of a glutamic acid and paraamidephenoxide, which serve as a linker.

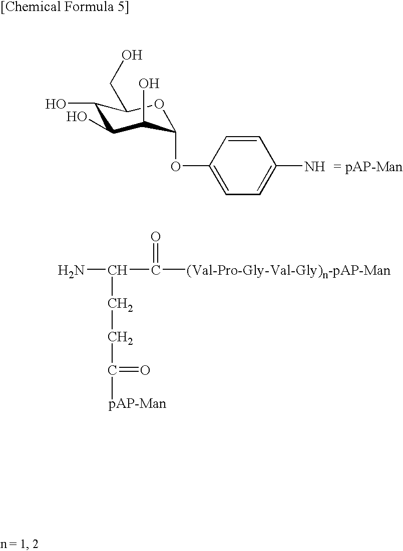

The fifth preferred embodiment of the present invention is a glycopeptide of which part of the elastin model peptide is modified and the C-terminal thereof is bonded to a mannose via paraamidephenoxide, which serves as a linker, and the N-terminal thereof is bonded to a mannose via the side chain of a glutamic acid and paraamidephenoxide, which serve as a linker.

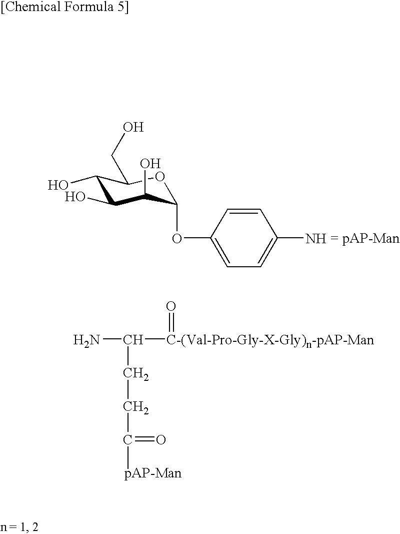

(where X is any amino acid residue.)

The sixth preferred embodiment of the present invention is a peptide of which part of the elastin model peptide is modified and both the C- and N-terminals are bonded to any sugar chain.

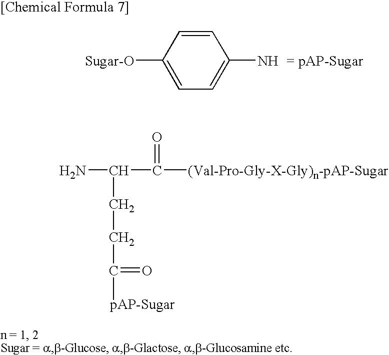

(where X is any amino acid residue.)

The seventh preferred embodiment of the present invention is the following peptide of which the N-terminal of the elastin model peptide is protected and a sugar is bonded.

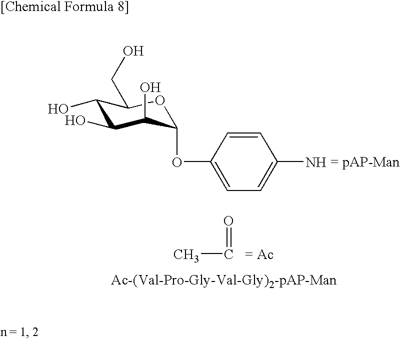

The eighth preferred embodiment of the present invention is the following peptide of which the N-terminal of the elastin model peptide is protected and a sugar is bonded.

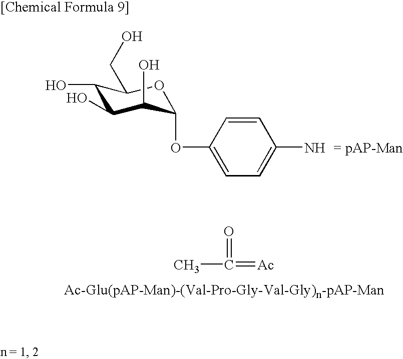

### Synthesis Method of Glycopeptides

### (With no L1)

First, Fmoc-(Val-Pro-Gly-X-Gly)n-OH is synthesized by solid phase synthesis using the Fmoc method. Next, a linker bound-type sugar chain, of which a linker is covalently bonded at the anomeric position of the sugar chain by a known method, is covalently bonded to the C-terminal of the oligopeptide, which is synthesized through glycosylation in advance, to obtain sugar chain-bound type oligopeptide. Thereafter, a Fmoc group provided at the N-terminal of the peptides is deprotected, purified by the reversed-phase silicagel chromatography, and lyophilized to obtain the desired glycopeptides.

### (With L1)

The case of using glutamic acid will be described below.

First, Fmoc-Glu(Val-Pro-Gly-X-Gly)n-OH is synthesized by solid phase synthesis using the Fmoc method.

Next, a linker bound-type sugar chain, of which a linker is covalently bonded at the anomeric position of the sugar chain by a known method, is covalently bonded to the C-terminal of the oligopeptide, which has been synthesized through glycosylation in advance, and to the side chain of the glutamic acid to obtain oligopeptide of which both terminals are bonded to the sugar chain. Thereafter, the desired glycopeptides are obtained through the procedure similar to the aforementioned one.

### Temperature-Responsive Micelles

In the glycopeptides of the present invention, the peptides act as temperature-responsive hydrophobicity when the glycopeptides aggregate in response to temperature, and the sugar chains act as hydrophilicity. Therefore, the glycopeptides easily form temperature-responsive micelles in water.

Generally, when the temperature is high, the hydrophobicity of the peptide increases and tends to saturate at a certain level. As a result, the particle diameter of the micelles increases as the temperature increases and tends to reach a certain maximum particle diameter.

The maximum particle diameter of the micelles can be controlled within a range of 100 to 10000 nm by appropriately selecting the peptide and the sugar chain.

### EXAMPLES

The present invention will be explained in more detail by the following examples, but is not intended to be limited by the examples.

First, Compound 1, Compound 4 and Compound 8 were synthesized using mannose and Fmoc amino acids (produced by Peptide Institute, Inc.) as a starting material.

Next, measurements of CD spectrum and micelle formation by dynamic light scattering were performed on these compounds. The micelles composed of Compound 1 were tested to verify temperature-responsiveness, and were inspected to verify aggregation using a gas-liquid interfacial monolayer. Furthermore, the micelles were bonded to concanavalin A, which is carbohydrate recognition lectin, through the fluorescence quenching experiment.

The synthesis and measurement methods and the results thereof will be specifically described below.

### A) Synthesis of Penta-O-acetyl-D-mannose

Acetic anhydride (88 ml) and pyridine (78 ml) were introduced into an eggplant type flask and cooled to 0° C. in an ice bath, and thereafter D-mannose (10.00 g, 5.4 mmol) was added and magnetically stirred. The reaction was traced with TLC (the developing solvent; ethyl acetate:hexane=2:1). Pyridine, together with toluene, was subjected to azeotropy and was concentrated in vacuo. The concentrated substance was dissolved in ethyl acetate and sequentially washed with IN hydrochloric acid, saturated water solution of NaHCO₃ and water. The solution was dried with anhydrous magnesium and then was concentrated in vacuo (percent yield >99%).

### B) p-Nitrophenyl-tetra-O-acetyl-α-D-mannoside

Molecular sieve 4 A (angstrom) was introduced into a two neck flask and was dried to be under nitrogen atmosphere. Penta-O-acetyl-α-D-mannoside (10.0 g, 25.6 mmol) and p-nitrophenyl (10.7 g, 76.86 mmol, 3 eq) were dissolved in dichloromethane and introduced into the flask, and then stirred for about one hour. Boron trifluoride ether complex (12.8 ml, 4 eq) was then added and stirred overnight. The progress of reaction was traced with TLC (hexane:ethyl acetate=1:1). Then, the solution was magnetically stirred. The solution was diluted with chloroform, and washed three times with 1 N NaOH and three times with water. Magnesium sulfate was added and stirred. The reaction was completed 28 hours later. Molecular sieve was filtered with Celite® and the solution was dried. After filtering the magnesium sulfate, yellow solid, to which toluene was added and which was subjected to azeotropy, was recrystallized with ethyl acetate and hexane to obtain a white crystal.

Yield 9.1 g

Percent yield 74.8%

C) p-Nitrophenyl-α-D-mannoside

p-Nitrophenyl-tetra-O-acetyl-α-D-mannoside (93.9 mg, 0.2 mmol) and sodium methoxide (4.7 eq) were dissolved in 7.1 ml of methanol and stirred. The progress of reaction was traced with TLC (chloroform:methanol=3:1) and the reaction was stopped one hour later. Then, the compound was neutralized with Amberlyst® and was concentrated in vacuo.

### D) p-Aminophenyl-α-D-mannoside

p-Nitrophenyl-α-D-mannoside was dissolved in methanol, and palladium hydroxide (6 mg) was added. A three-way cock was attached to a flask, and then a hydrogen balloon was attached thereto to perform hydrogen gas replacement in the flask. Under such condition, stirring was performed and the progress of reaction was traced with TLC (chloroform:methanol=3:1). Completion of the reaction was verified 16 hours later, and palladium was filtered. The filtrate was concentrated in vacuo and used in the next reaction.

### [Peptide Solid Phase Synthesis]

### E) The following peptides were synthesized by the known peptide synthesis methods.

Peptide 1: Fmoc-Val-Pro-Gly-Val-Gly-Val-Pro-Gly-Val-Gly
Peptide 2: Fmoc-Val-Pro-Gly-Val-Gly
Peptide 3: Fmoc-Glu-Val-Pro-Gly-Val-Gly-Val-Pro-Gly-Val-Gly
Peptide 4: Fmoc-Glu-Val-Pro-Gly-Val-Gly
Peptide 5: Ac-Val-Pro-Gly-Val-Gly-Val-Pro-Gly-Val-Gly
Peptide 6: Ac-Glu-Val-Pro-Gly-Val-Gly-Val-Pro-Gly-Val-Gly

Purification was performed by a reversed-phase HPLC column and synthesis was verified by the MALDI-MS spectrum (Voyager manufactured by Applied Biosystems).

### F) Synthesis of Compound 1 (NH₂-Val-Pro-Gly-Val-Gly-Val-Pro-Gly-Val-Gly-pAP-Man)

Peptide 1 (140 mg, 0.13 mmol) was dissolved in anhydrous DMF and cooled to 0° C. 2-(1H-7-azabenzotriazole-1-yl)-1,1,3,3-tetramethyluronium hexafluorophosphate (HATU) (59.3 mg, 1.2 eq) and diisopropylethylamine (DIEA) (54 μl, 2.4 eq) were then added and stirred. DMF solution (1.5 eq) of p-aminophenyl-α-D-mannoside was added and then stirred at room temperature. The progress of reaction was traced with TLC (chloroform:methanol=1:2), and 0.5 eq of HATU and 1.0 eq of DIEA were added thereto three hours later. One hour later, the reaction was stopped and the solvent was concentrated in vacuo and then removed. The compound was then purified with LH20 gel column (produced by Pharmacia; solvent methanol) to obtain Fmoc-Val-Pro-Gly-Val-Gly-Val-Pro-Gly-Val-Gly-pAP-Man.

Piperidine (20%) DMF solution was added to Fmoc-Val-Pro-Gly-Val-Gly-Val-Pro-Gly-Val-Gly-pAP-Man, and stirred for two hours. After the removal of Fmoc protecting group was verified, the solvent was concentrated in vacuo. The solution was then recrystallized from methanol and acetonitrile and was subjected to the centrifugation to obtain a solid. Part of the solid was further purified with HPLC (0.1% TFA water:methanol=1:1) to obtain a white solid (Compound 1).

Yield 6.3 mg

Percent yield 4.4%

Purity 98.3% (analyzed by HPLC 0.1% TFA water:methanol=1:1)

Molecular weight 1113.6 [M+Na]⁺

### Synthesis of Compound 4 (NH₂-Glu(pAP-Man)-Val-Pro-Gly-Val-Gly-Val-Pro-Gly-Val-Gly-pAP-Man)

Peptide 3 (140 mg, 0.118 mmol) was dissolved in anhydrous DMF and cooled to 0° C. HATU (107 mg, 1.2 eq) and DIEA (90 μl, 2.4 eq) were added and stirred. DMF solution (1.5 eq) of p-aminophenyl-α-D-mannoside was added and then stirred at room temperature. The progress of reaction was traced with TLC (chloroform:methanol=1:1), and the reaction was completed 24 hours later. The solution was then concentrated in vacuo to remove DMF, and purified with LH20 gel column (solvent methanol). Piperidine (20%) DMF solution was added to the obtained compound Fmoc-NH₂-Glu(pAP-Man)-Val-Pro-Gly-Val-Gly-Val-Pro-Gly-Val-Gly-pAP-Man, and stirred for about 30 minutes. After the removal of Fmoc protecting group was verified, the solvent was concentrated in vacuo. The compound was purified with reversed-phase silicagel column chromatography (water:methanol=1:1) and was lyophilized to obtain a white solid.

Yield 37 mg

Percent yield 21.3%

Purity 95.1% (analyzed by HPLC 0.1% TFA water:methanol=1:1)

Molecular weight 1495.7 [M+Na]⁺

### H) Synthesis of Compound 8 (Ac-Val-Pro-Gly-Val-Gly-Val-Pro-Gly-Val-Gly-pAP-Man)

Peptide 5 (40 mg, 0.091 mmol) was dissolved in anhydrous dimethyl acetamide and cooled to 0° C. HATU (26 mg, 1.2 eq) and DIEA (24 μl, 2.4 eq) were added and stirred. DMA solution of pAP-mannoside (1.5 eq) was added and then stirred at room temperature. The progress of reaction was traced with TLC (chloroform:methanol=2:3), and the reaction was stopped 24 hours later. The solvent was concentrated in vacuo and then removed. The compound was then purified with silicagel column chromatography (solvent; chloroform:methanol=2:3) and the residual silicagel was removed with LH20 column (solvent; methanol). A white solid (Compound 8) was then obtained by lyophilization.

Yield 38 mg

Percent yield 73%

Purity 97.2% (analyzed by HPLC 0.1% TFA water:methanol=1:1)

Molecular weight 1155.3 [M+Na]⁺

### I) CD Spectrum Measurement

The conformation change according to the temperature of the glycopeptides (Compounds 1 and 4) obtained in the aforementioned methods was measured using a CD spectrum (J-720 manufactured by JASCO Corporation). PBS buffered solution of the glycopeptides of 5×10⁻⁴ (M) was subjected to CD spectrum measurement using a quartz cell having an optical path length of 1 mm.

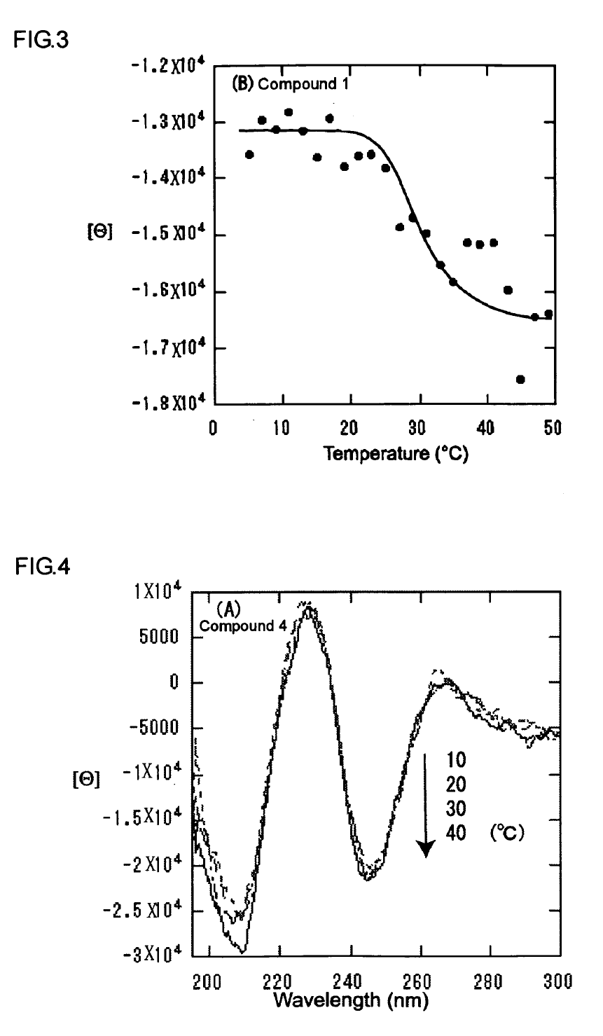

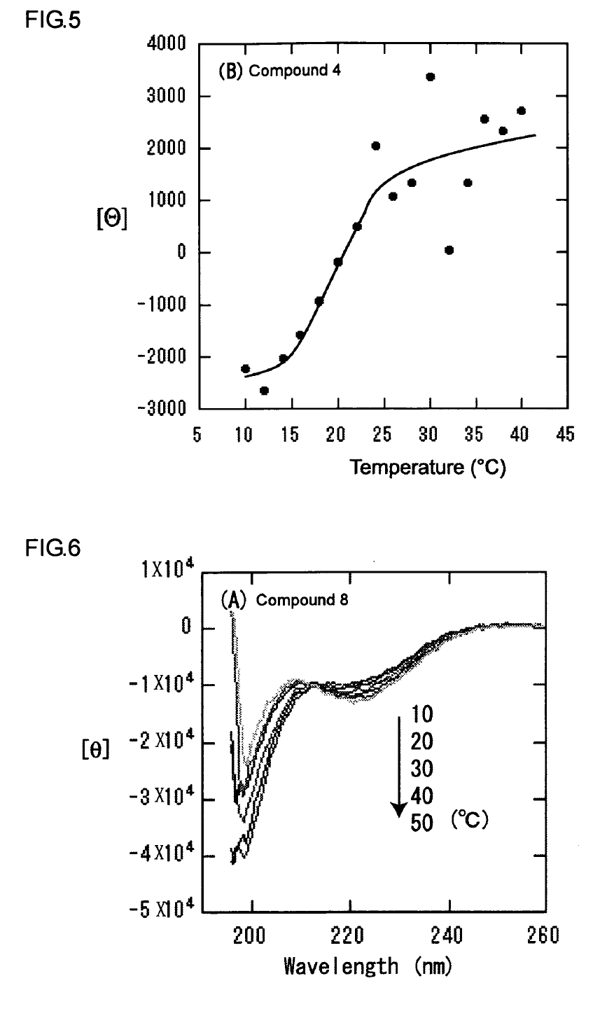

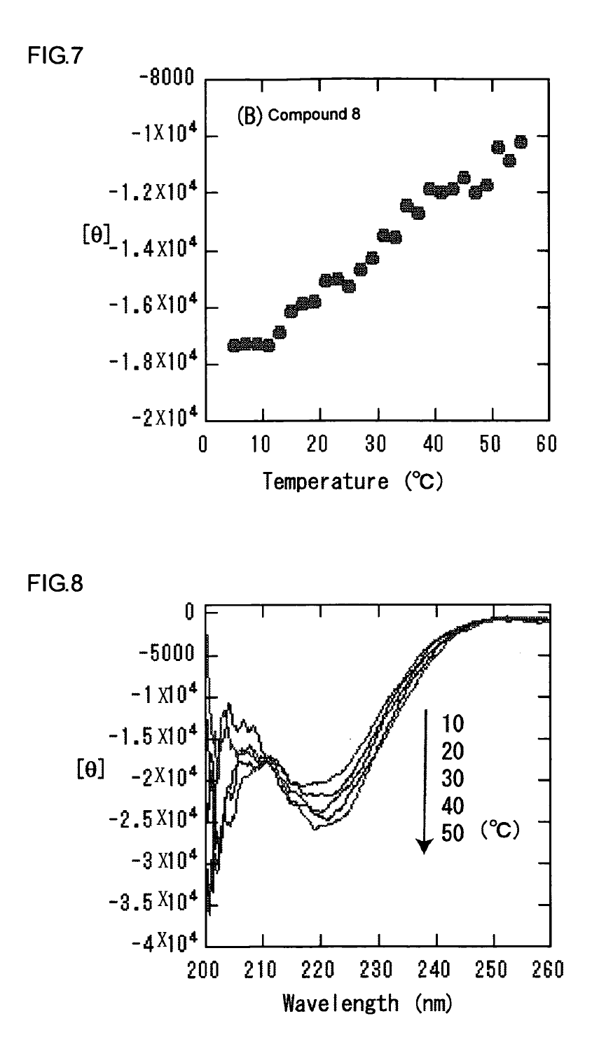

The CD spectra of Compound 1, Compound 4 and Compound 8 were measured at temperature range of 5° C.-50° C. The CD spectrum changed together with the temperature, and it was shown that changes of structure occurred at around 25° C. to 30° C. The structural change according to the temperature change similar to the structural change of peptides of interest. In particular, since Compounds 1 and 8 have similar behavior, it was shown that the conformation change of the peptide was substantially the same as that of elastin model peptide. See Compound 1 (FIGS. 2 and 3), Compound 4 (FIGS. 4 and 5), Compound 8 (FIGS. 6 and 7) and Reference Compound (FIGS. 8 and 9).

FIGS. 2 and 3: (A) CD spectrum of Compound 1; (B) [Θ] at temperatures in 220 nm (where Θ refers to Molecular ellipticity; hereinafter refers to the same)

FIGS. 4 and 5: (A) CD spectrum of Compound 4; (B) [Θ] at temperatures in 206 nm

FIGS. 6 and 7: (A) CD spectrum of Compound 8; (B) [Θ] at temperatures in 220 nm

FIGS. 8 and 9: (A) CD spectrum of Reference Compound; (B) [Θ] at temperatures in 220 nm

### J) Measurement of Micelle Formation by Dynamic Light Scattering

The micelle formation was observed by measuring the particle diameter of glycopeptides using dynamic light scattering (DLS; HK-6600 manufactured by Otsuka Electronics Co., Ltd.).

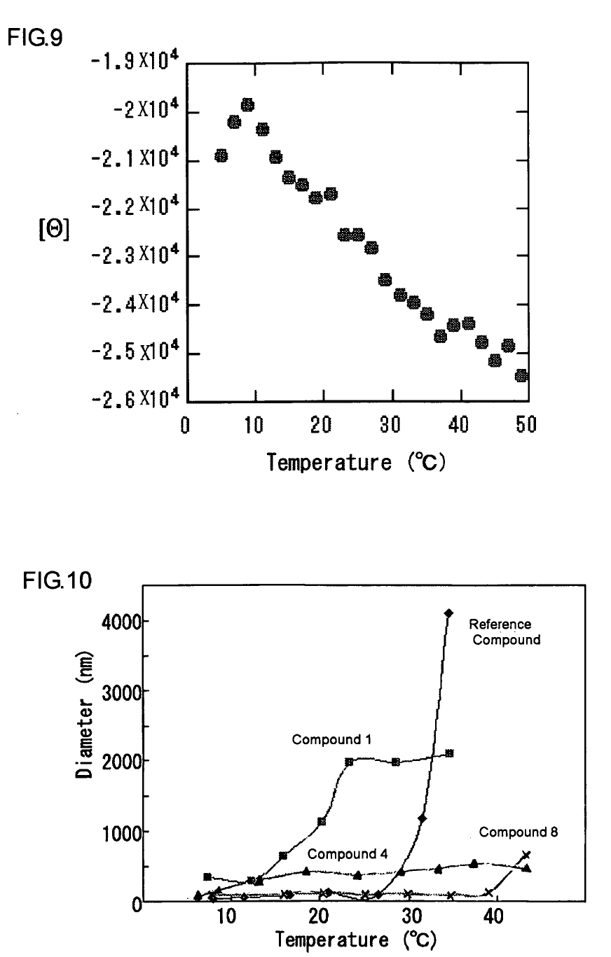

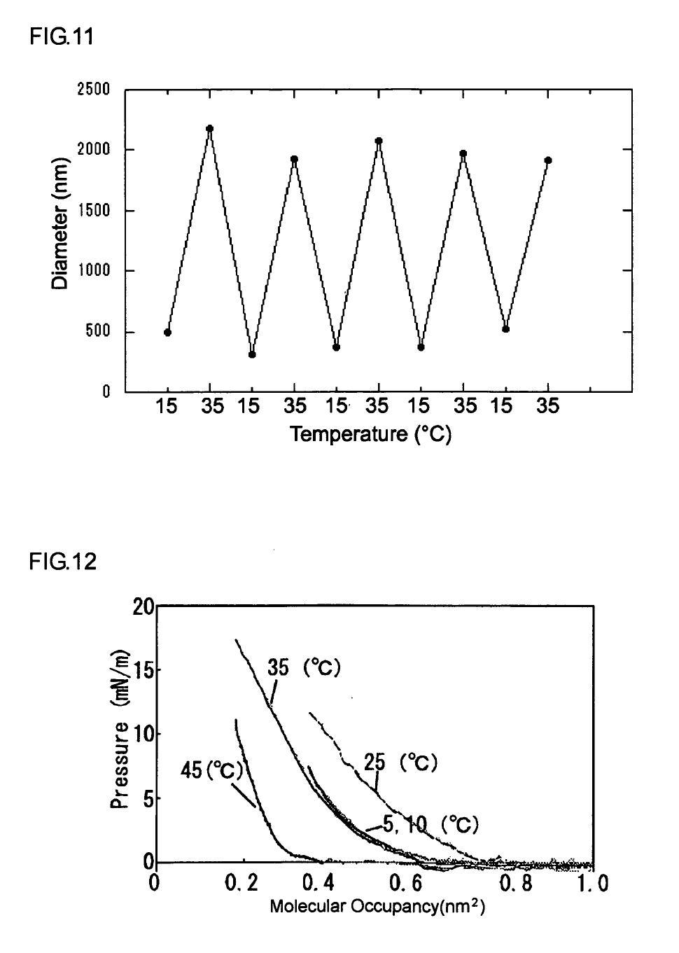

The particle diameters of Compounds 1, 4 and 8 and a peptide (NH₂-Val-Pro-Gly-Val-Gly-Val-Pro-Gly-Val-Gly-OH) having no sugar as a reference molecule in the solution were measured at various temperatures. Compound 1 formed a micelle having a diameter of 2 μm at 25° C. or more and Compound 4 formed a micelle having a diameter of 400 nm. In contrast, it was found that the reference peptide molecule formed an aggregate having a very large particle diameter. Therefore, it was shown that when a sugar was added to the elastin model peptide (NH₂-Val-Pro-Gly-Val-Gly-Val-Pro-Gly-Val-Gly-OH), the compound became amphipathic and formed micelle having a constant particle diameter (see FIG. 10).

In the case of Compound 8 to which a protecting group was added at the N-terminal, the temperature at which an aggregate was formed changed to 35° C. or more, and it was shown that the formation temperature of the aggregate could be controlled by protecting the N-terminal.

Since a temperature-responsive polymer such as poly(N-isopropylacrylamide), and a temperature-responsive polymer composed of multimer of the elastin model peptide are macromolecules, time lag (normally a few hours to 24 hours) in temperature-responsiveness is observed. In contrast, since the glycopeptides of the present invention are composed of small molecules at angstrom level, responsiveness is quick and is being maintained even after repetition.

For the solution of Compound 1, the temperature was varied between a temperature range of 15° C. to 35° C. for 15 minutes, the temperature variation was repeated, and the particle diameters were measured at 15° C. and 35° C.. It was found that the micelle composed of Compound 1 repeated in cycles in which the particle diameter increased as the temperature increased and decreased as the temperature decreased, and substantially complete micelle formation was observed at least five times (see FIG. 5).

### K) Measurement of Molecule Aggregation Formation of Gas-Liquid Interfacial Monolayer

Aggregation at the gas-liquid interface of the glycopeptides were analyzed by the LB film-forming apparatus (manufactured by Nippon Laser & Electronics Lab.).

Compound 1 and the peptide having no sugar as a reference molecule (NH₂-Val-Pro-Gly-Val-Gly-Val-Pro-Gly-Val-Gly-OH) were used. These peptides were dissolved in distilled chloroform to obtain a solution concentration of 20 μl. The compound was inoculated on the gas-liquid interface with Hamilton Gastight Syringe. After 10 min. of still standing, the π-A curves were measured. The behavior of monolayer on the gas-liquid interface changed according to the changes of the temperature-responsive hydrophobic part of the molecule. As the temperature increased from 5° C., 10° C. to about 25° C., the peptide part became hydrophobic, and therefore the interaction between the molecules changed and the monolayer expanded. When the temperature was further increased, the monolayer was aggregated to have a small molecular occupancy (see FIG. 12).

For Compound 1, molecular occupancy of π-A curve with increased temperature of 45° C. became smaller, and the curve of the π-A curve of the molecule also became steep. Since the peptide became amphipathic at high temperatures, it was shown that the orientation of the molecules of glycopeptides was changed to be nearly perpendicular to the interface (see FIG. 12).

### INDUSTRIAL APPLICABILITY

The temperature-responsive glycopeptides of the present invention are reversible, have quick temperature responsiveness, and form micelles. Moreover, as being temperature-responsive molecules at the angstrom level, the glycopeptides are used in Drug Delivery Systems (DDS) or other molecular devices that require accurate responsiveness.

Specifically, assume that a drug administered to a biological body is administered to a targeted tissue at a required time with only a required amount, and the glycopeptides of the present invention are used in Drug Delivery Systems that provide effective medication. Due to the quick temperature-responsiveness, the glycopeptides of the present invention, for example, quickly respond to a body temperature or a skin temperature of the biological body, or temperature stimulus applied from the external of the biological body, and release the internal capsule drug of micelles. Therefore, the glycopeptides of the present invention have a high value of applicability in medical, pharmaceutical and cosmetic fields. In addition, since a sugar chain specifically interacts with cells, pathogens, toxins and viruses, the glycopeptides of the present invention forming micelles can organ-specifically, pathogen- or toxin-specifically transmit agents. Therefore, the present glycopeptides can be used in the DDS having both features of emission-control type and targeting type, and be very useful for industry. Moreover, the glycopeptides of the present invention can be used as sugar chains for modification. For example, when the glycopeptides of the present invention are bounded to the targeted protein using the sugar chains of the present glycopeptides in a process of glycosylation, which is one of posttranslational modification of the protein, the structure of the protein can be changed in response to temperatures. Therefore, the glycopeptides of the present invention can also control inactivation or increase in activation of the protein including enzyme in response to temperatures, and thus the glycopeptides of the present invention can also be of high interest in the medical field.

1.-5. (canceled)

6. A temperature-responsive micelle composed of synthesized glycopeptide, the glycopeptide being represented by the following chemical formula (1): 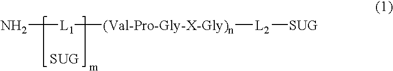
(where x is any amino acid residue, L₁ and L₂ are linkers, SUGs are sugar chains, m is 0 or 1 and n is an integer from 1 to 10, and L₁ and L₂ may be identical with or different from each other and SUGs may be identical with or different from each other).

7. The micelle according to claim 6, wherein SUGs in the formula (1) are sugar chains of monosaccharide or oligosaccharide.

8. The micelle according to claim 6, wherein x in the formula (1) is Val.

9. The micelle according to claim 6, wherein m in the formula (1) is 0.

10. The micelle according to claim 6, wherein a protecting group is present at the N-terminal of the glycopeptide.

11. The micelle according to claim 6, wherein the maximum particle diameter of the micelle is controlled within a range of 100 to 10000 nm.
